(19) United States
(12) Patent Application Publication
(10) Pub. No.: US 2011/0273279 A1
(43) Pub. Date: Nov. 10, 2011

(54) VEHICLE SYSTEM INTERACTION USING REMOTE DEVICE

(75) Inventors: Karl Douglas Vandivier, Belleville, MI (US); Robert Bruce Kleve, Farmington, MI (US); Paul Aldighieri, Grosse Pointe Farms, MI (US); John Robert Van Wiemeersch, Novi, MI (US); Steven Yellin Schondorf, Dearborn, MI (US)

(73) Assignee: Ford Global Technologies, LLC, Dearborn, MI (US)

(21) Appl. No.: 12/776,632

(22) Filed: May 10, 2010

(51) Int. Cl. G06K 7/01; G01C 21/00

(52) U.S. Cl. 340/10.4; 340/10.51; 701/213

(57) ABSTRACT

A method for querying a vehicle system from a remote wireless device includes receiving an inquiry at a cellular transceiver included in a vehicle. The inquiry is sent from a remote server in communication with the remote wireless device and initiated by the remote wireless device. The method includes accessing one or more vehicle systems in accordance with the inquiry and querying the accessed one or more systems in accordance with the inquiry. The method also includes receiving information in accordance with the query from the one or more systems that were queried and transmitting the received information to the remote server through the cellular transceiver, for further transmission to the remote wireless device.

### BACKGROUND

1. Technical Field

The illustrative embodiments generally relate to vehicle system interaction using a remote device.

2. Background Art

Cellular phone and PDA displays are growing increasingly capable of displaying an ever more complex variety of information. Color, touch-sensitive displays can present a user with graphic interfaces, detailed figures, and a variety of other interactive information.

Additionally, there is an increasing need in society to have information access on-demand. In a world of GOOGLE, YAHOO! and WIKIPEDIA, users are growing used to having any and all desired information at their fingertips.

This information, while useful in many areas, is also often static information. That is, it is fixed, factual information. Integration, however, of dynamic “facts” has slowly begun.

For example, it may be possible for a person to log on to the internet and check to see if the alarm system in their house is armed, or even to arm the system. As another example, a person can log on to the internet and set a DVR device to record a desired show, and/or check preset recordings.

Networked systems provide much more than information, they are becoming integrated into everyday items and occurrences, so that they are providing additional control and information about common events. Many everyday items, however, such as vehicles, lack complete or even partial integration into these systems.

### SUMMARY

In a first illustrative embodiment, a method for querying a vehicle system from a remote wireless device includes receiving an inquiry at a cellular transceiver included in a vehicle. In this illustrative embodiment, the inquiry was sent from a remote server in communication with the remote wireless device. The inquiry was initiated by the remote wireless device.

The illustrative method includes accessing one or more vehicle systems in accordance with the inquiry and querying the accessed one or more systems in accordance with the inquiry.

The method also includes receiving information in accordance with the query from the one or more systems that were queried and transmitting the received information to the remote server through the cellular transceiver, for further transmission to the remote wireless device.

In a second illustrative embodiment, a method for updating a vehicle system from a remote wireless device includes receiving an update command at a cellular transceiver included in a vehicle. In this embodiment, the update command also has been sent from a remote server in communication with the remote wireless device. The update command was initiated by the remote wireless device.

This method includes accessing one or more vehicle systems in accordance with the update command, and updating the one or more accessed systems in accordance with the update command.

In a third illustrative embodiment, a computer readable storage medium stores one or more instructions executable by a processor in machine-readable format. Upon execution of the instructions by a processor, the processor is caused to perform the steps of the first or second methods presented above.

### BRIEF DESCRIPTION OF THE DRAWINGS

FIG. 1 shows an illustrative example of a communication system through which a nomadic device can communicate with a vehicle;

FIGS. 2a-d show illustrative examples of vehicle-based communication modules that provide communication to a remote network;

FIG. 3 shows an illustrative example of communication between a remote wireless device and a vehicle based wireless device;

FIG. 4 shows an illustrative example of a process for checking a variety of vehicle information remotely;

FIG. 5 shows an illustrative example of a process by which a vehicle system receives an inquiry command from a remote network 501 transmitted to a cellular transceiver;

FIG. 6 shows an illustrative example of a process for transmission of additional information to the querant's remote device as the result of a query; and

FIG. 7 shows an exemplary process for updating a vehicle system using a remote device.

### DETAILED DESCRIPTION

Detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

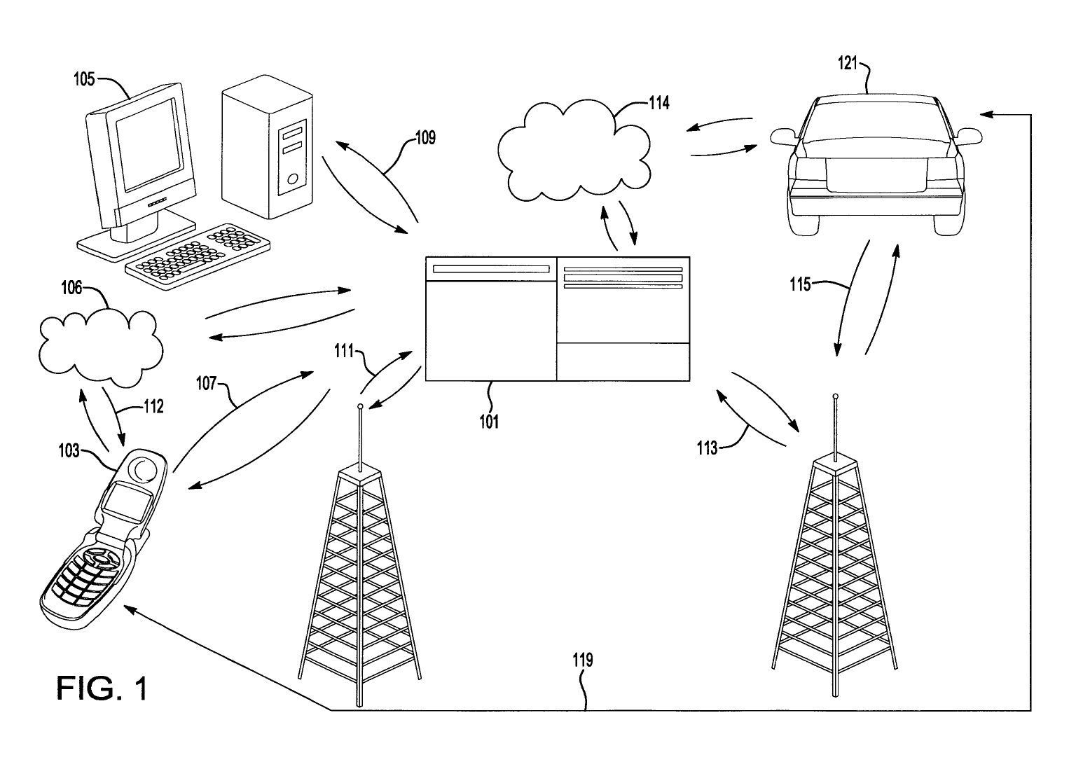

FIG. 1 shows an illustrative example of a communication system through which a nomadic device can communicate with a vehicle 121. In this illustrative embodiment, a nomadic device (e.g., without limitation, a cellular phone) 103 is used to send a communication through a cellular network 107. This communication is relayed through a network 111 (e.g., without limitation, the cellular network, the internet, etc.) to a centralized system 101. A system similar to the system shown in FIG. 1 is available from CRAYON INTERFACE, INC.

In this illustrative embodiment, the centralized system is a server system that includes processing capability for incoming nomadic device signals designated to interact with a remote vehicle 121.

For example, the server(s) 101 may include an automated call server and/or web host. Further, the server(s) 101 may route an incoming signal from a nomadic device (ND) 103 to the appropriate remote vehicle. Data sent in this fashion may be sent using data-over-voice, a data-plan, or in any other suitable format.

In another embodiment, the nomadic device 103 may send a communication through network 112 which may include, but is not limited to, WiFi or WiMax. This communication is relayed through a network 106 (e.g., without limitation, the internet,) to a centralized system 101.

Data can also be sent to the remote vehicle 121 through the server(s) 101 using a personal computer 105. In this case, the data is likely, although not necessarily, sent over the internet 109.

Once the server(s) 101 receive the incoming data request from the remote source 103, 105, the message is processed and/or relayed to a vehicle 121. The vehicle may be identified by a header associated with one or more incoming data packets, or may be identifiable based on a database lookup, for example.

The relay to the vehicle 121 is sent out from the server(s) 101 through a network (e.g., without limitation, a cellular network 113, the internet, etc.) and passed through a cellular network 115 to the vehicle 121. In one embodiment, the relay may be passed through a broadband network 114 (e.g., 802.11g or WiMax). A remote communication module 200 in the vehicle 121 receives the signal sent from the server(s) 101 and processes it or relays it to an appropriate processing system within the vehicle 121.

In at least one illustrative embodiment, the vehicle 121 is also outfitted with a communication transceiver, such as, but not limited to, a BLUETOOTH transceiver. This transceiver may allow communication with the nomadic device 103 using a direct signal 119 if, for example, cellular networks are unavailable.

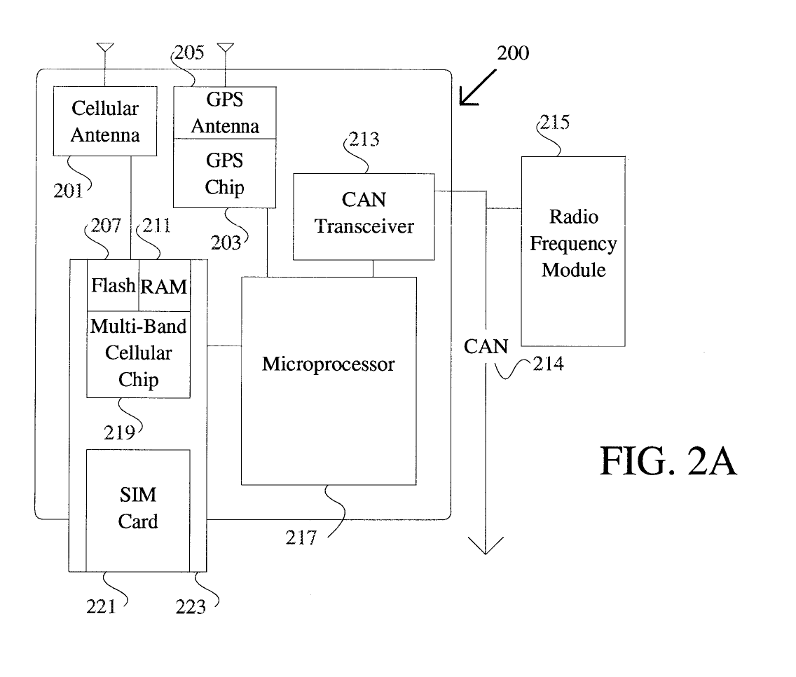

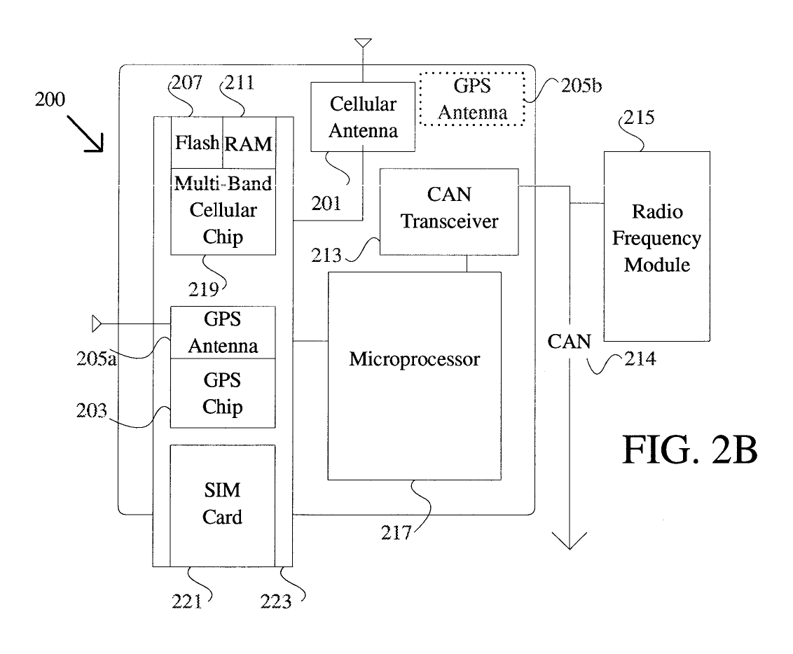

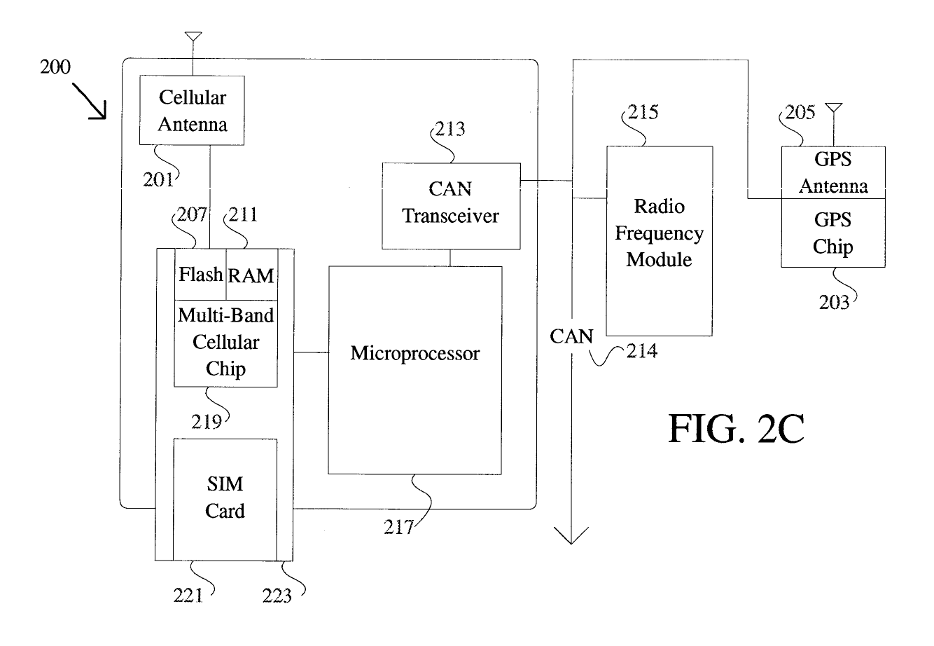

FIGS. 2a-d show illustrative examples of vehicle-based communication modules that provide communication to a remote network.

FIG. 2a shows an illustrative example of a communication module 200 combined with a GPS module, wherein a cellular module and GPS are on different boards.

In this illustrative embodiment, a communications module 200 can include a cellular (e.g., and without limitation, GSM or CDMA) antenna 201 that communicates with a remote server over a cellular network. The received cellular signal may be sent from the cellular antenna 201 to a multi-band cellular (e.g., and without limitation, GSM or CDMA) decoder 219 that processes the received signal to produce information usable by the microprocessor 217.

In this illustrative embodiment, the multi-band cellular chip 219, including flash memory 207 and RAM 211, is installed in the module as part of a removable device 223 including a SIM card 221. The SIM card 221 may contain user identifying information that allows access to the cellular network under a particular user's plan.

Additionally or alternatively, the module includes a GPS chip 203 that can process and decode a signal from the GPS antenna 205 and send this information to a microprocessor 217.

The microprocessor is also in communication with a vehicle data bus that provides access to various vehicle modules, such as RF module 215. Other modules not shown include, but are not limited to, the vehicle cluster, a remote (off-board) GPS system, a radio module, etc. Non-limiting examples of a vehicle data bus include an SAE J1850 bus, a CAN bus, a GMLAN bus, and any other vehicle data buses known in the art. For illustration purposes only, FIGS. 2a-2d are represented as using a CAN bus.

FIG. 2b shows a second exemplary embodiment in which a cellular chip and GPS are on the same board 223. In this illustrative embodiment, the removable board (this board may also be permanently attached to the module) 223 may contain the SIM card 221, a GPS module including a GPS chip 203 and a GPS antenna 205a, and the Multi-band cellular chip 219 including flash memory 207 and RAM 211.

In another embodiment, the GPS antenna 205b may be attached to the module separately from this board 223. When a signal comes in from the cellular antenna 201 and/or the GPS antenna 205b, the signal may be sent to the corresponding cellular/GPS chip 203 for processing, and then passed to the microprocessor 217. The microprocessor 217 interfaces with the CAN transceiver 213 to connect to a vehicle network 214 and vehicle modules such as RF module 215.

FIG. 2c shows yet another exemplary embodiment in which the cellular module is standalone. In this illustrative embodiment, the GPS module containing the GPS antenna 205 and the GPS chip 203 may connect to the microprocessor 217 through the CAN transceiver 213. Other vehicle modules, such as an RF module 215 can also connect to the microprocessor through the CAN transceiver 213.

In this illustrative embodiment, the removable board 223 may contain a SIM card 221 and a multi-band cellular chip 219, as well as a flash memory 207 and RAM 211. Signals from the cellular antenna 201 may be sent to the board 223 for processing by the multi-band cellular chip 219 before being sent to the microprocessor 217.

FIG. 2d shows still another exemplary embodiment in which a cellular module is combined with an RF module 215 in the communications module 200. The RF module 215 may continue to talk to the microprocessor 217 through the CAN transceiver 213. In this illustrative embodiment, the GPS module, including the GPS antenna 203a, 203b and GPS chip 205a, 205b can be located within the communications module 200 or located elsewhere in the vehicle, in which case it may communicate with the microprocessor 217 through the CAN transceiver 213.

Again, in this embodiment, the cellular antenna 201 may send a signal to the multi-band cellular 219, including flash memory 207 and RAM 211. The signal may be processed and sent to the microprocessor 217. The multi band cellular chip 219 may be located on a removable circuit board 223, which may also include a SIM card 221.

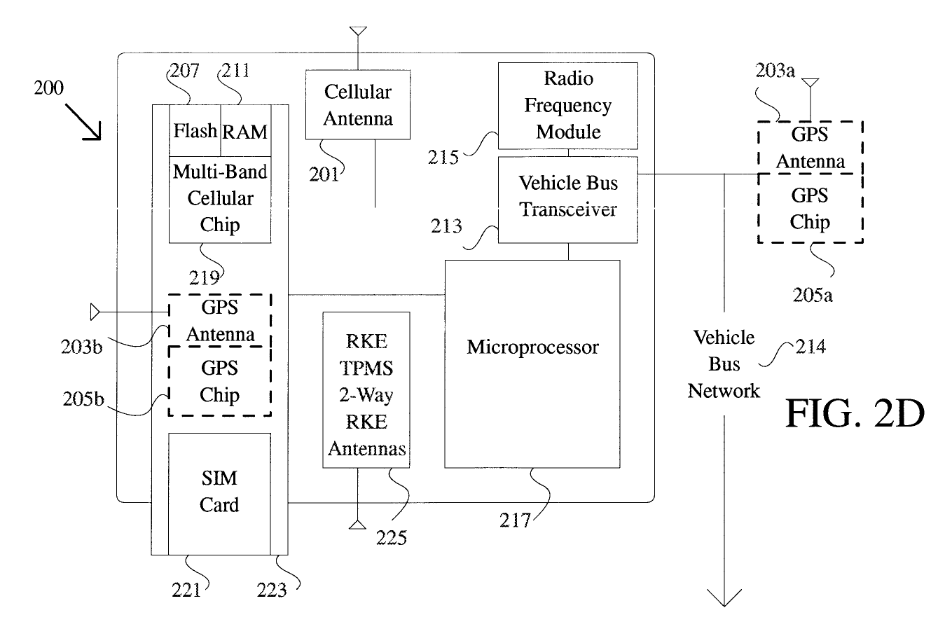

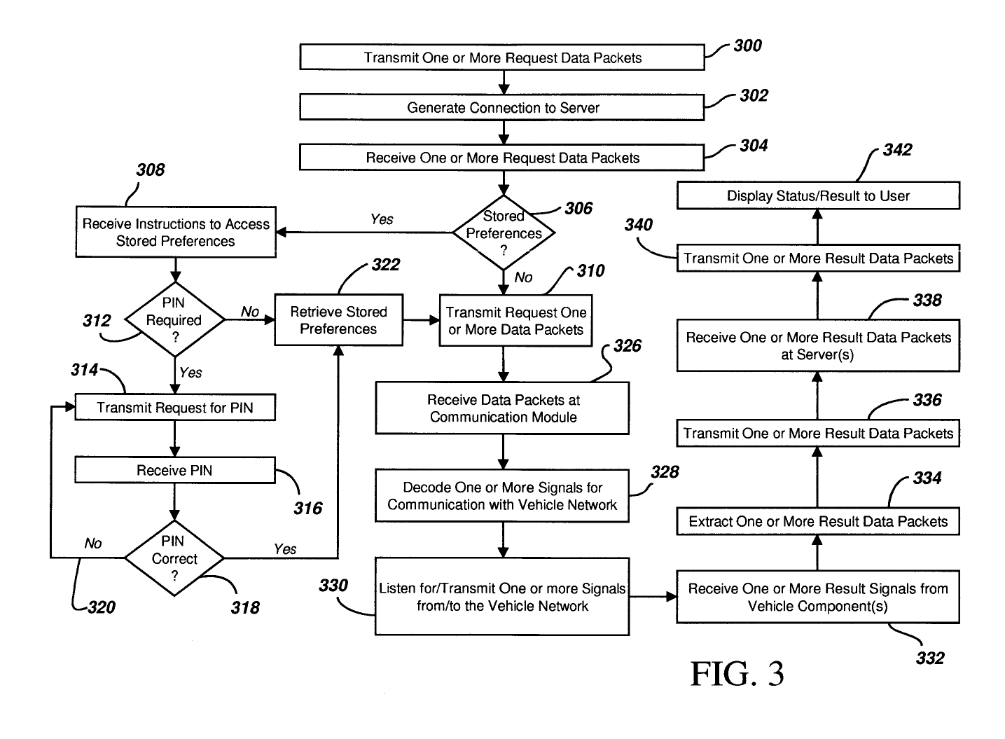

FIG. 3 illustrates the operation of a communication module 200 according to one illustrative embodiment. The nomadic device (ND) 103 and/or computer 105 may include software for facilitating the operation of the one or more embodiments. The software may be downloaded to the ND 103 or computer 105 from a website (such as an OEM's website) or, as another example, come factory installed in the ND. In one embodiment, the software may be a programmed in the JAVA language (manufactured and distributed by Sun Microsystems).

In one or more exemplary embodiments, a user may control one vehicle with multiple NDs 103 or computers 105. Additionally or alternatively, the user may use one ND 103 or computer 105 to operate components of multiple vehicles.

The user may activate and operate the software using one or more button or key presses from his or her ND 103 and/or computer 105. In one illustrative embodiment, the ND 103 and/or computer 105 may be equipped with a hot-key from which the software may be activated. Alternatively or additionally, the user may activate and operate the software through a menu selection from a graphical user interface (GUI) displayed on the ND 103 and/or computer 105.

Further, computer readable storage mediums, including, but not limited to, hard disk drives, persistent and non-persistent memory, floppy disks, CDs, DvDs, flash drives, zip drives, etc. may contain instructions that facilitate one or more of the illustrative embodiments. The instructions are typically machine readable and executable by a processor on, for example, without limitation, the nomadic device, the server, and/or the vehicle based microprocessor.

Alternatively or additionally, the user may operate and activate the software through one or more voice-activated commands received by the ND 103 and/or computer 105. The ND 103 and/or computer 105 may include speech recognition software for interpreting and processing commands from a user into machine readable language. In one embodiment, the speech recognition software may be programmed and/or stored to the web server. Non-limiting examples of a user may be a vehicle owner, a vehicle passenger, a vehicle service technician, or a vehicle dealer.

Upon making the request (via, e.g., key button press or voice), one or more data packets may be transmitted from the ND 103 or computer 105 as illustrated in block 300. Non-limiting examples of data (i.e., information) transmitted in the data packets may include a mobile identification number (MIN), a customer identification number, the one or more commands triggered from the ND 103 and/or 105, and the vehicle identification number (VIN). Furthermore, in some embodiments, the one or more data packets transmitted from the ND 103 and/or computer 105 may include instructions for operating according to the one or more requests made by the user.

Referring back to FIG. 3, before or after the data packets are transmitted, a connection may be generated with the server(s) 101 as illustrated in block 302. The server(s) 101 may or may not be a web server. Once a connection to sever(s) 101 is made, the data packets may be received by the server(s) 101 as illustrated in block 304. Alternatively or additionally, a direct connection may be made between the ND 103 or computer 105 and the cellular communication module 200 (i.e., without making a connection to server(s) 101). Accordingly, the operation of one or more embodiments of the present invention may be accomplished without a server.

The server(s) 101 may process one or more received commands for transmission to the vehicle 121. Processing the data packet may include, but is not limited to, authenticating the one or more commands, authenticating the user (e.g., determining if the user is a registered user) and authenticating the cellular/mobile phone (e.g., matching the MIN to the VIN) transmitted in the data packet. In one non-limiting embodiment, the server(s) 101 may process the data packet using one or more look-up tables and validating the information in the data packets against the one or more tables.

The server(s) 101 may be in further communication with one or more databases (not shown). The data may be retrieved from third-party systems, OEM (e.g., vehicle) databases/servers or manually inputted by a user (e.g., an OEM).

In one exemplary embodiment, a determination may be made at the server(s) 101 if the user has any personal preferences as illustrated in block 306. While the preferences may be stored elsewhere, for purposes of illustration, FIG. 3 illustrates the operation based on the personal preferences being stored on the server(s) 101.

The personal preferences may be stored on the server(s) 101. Alternatively or additionally, the personal preferences may be stored in the ND's 103 or computer's 105 memory (not shown). In yet another embodiment, the personal preferences may be stored at the vehicle (e.g., on the SIM card 221, on the microprocessor 217 of the cellular communication module 200, or in a memory module present elsewhere in the vehicle). In this latter embodiment, the server(s) 101 may route the data packets to the vehicle without further processing.

Referring back to FIG. 3, if the user has personal preferences associated with one or more vehicle components, the server(s) 101 may receive instructions to access the stored preferences as illustrated in block 308. In one embodiment, the instructions may be transmitted with the one or more data packets received from the ND 103 and/or computer 105. The server(s) 101 may extract or read these instructions from the data packets to retrieve the stored personal preferences.

In one illustrative embodiment, a further determination may be made at server(s) 101 as to whether a personal identification number (PIN) is required to access the personal preferences or to operate one or more features of the software as illustrated in block 312. The PIN may be stored at server(s) 101 or may be transmitted with the data packets transmitted from the ND 103 and/or the computer 105. If a PIN is required, the server(s) 101 may transmit a request for the PIN as illustrated in block 314. The request may be transmitted to one or more memory locations (e.g., a database) on the server(s) 101 or to the remote terminals 103, 105. The PIN may be retrieved from the server(s) 101 using, for example, a look-up table based on information such as VIN, a customer number, a MIN, or other non-limiting identifiers. It should be understood that the PIN may be retrieved in any other means known in the art and the previous example is illustrative.

For example, it may be desirable to “PIN restrict” only certain features. A tracking feature, for example, may be PIN restricted, since it would allow a person who found a cellular phone to also find the vehicle, and possibly gain entry, depending on the features available on the phone. Accordingly, the tracking feature may require a PIN entry to activate.

In one illustrative embodiment, once a PIN has been entered once, it may not need to be re-entered until the phone has been deactivated and reactivated.

The server(s) 101 may receive the PIN as illustrated in block 316. The PIN may then be validated as illustrated in block 318. If the PIN is not correct, the server(s) 101 may re-transmit the request as represented by loop 320. In one embodiment, a user may reenter a PIN a predetermined number of times (e.g., 3 or 5 times) after entering an incorrect PIN. If the PIN is correct, the server(s) 101 may retrieve the personal preferences associated with the request, as illustrated in block 322, and transmit the one or more data packets with the stored preferences to the cellular communication module as illustrated in block 310.

If a PIN is not required to access the personal preferences or if there are no stored preferences, upon receiving the one or more data packets, the server(s) 101 may transmit the one or more data packets to the cellular communication module as represented in block 310. The one or more data packets may be transmitted over the network (e.g., cellular network 113 or the internet). The cellular communication module 200 may then receive (e.g., via GSM antenna 201) the one or more data packets over the network as represented in block 326. One or more signals for transmission to the vehicle CAN network 214 may then be generated (e.g., by the multi-band GSM decoder 219) as represented in block 328.

In one embodiment, the one or more signals may be decoded and translated for transmission to the CAN interface (e.g., CAN transceiver 213 and vehicle network 214) at the microprocessor 217 which may be in communication with the GSM decoder 219 via electrical communication. (Other vehicle system busses different from the CAN bus may also be communicated with/though) The one or more signals may be decoded for interpretation by the vehicle network 214. The one or more signals (including the data packets) may then be transmitted to the CAN interface (e.g., the CAN transceiver 213) as represented in block 330.

The CAN transceiver 213, upon receiving the one or more request signals, may transmit the one or more request signals to the one or more vehicle components via vehicle network 214.

After one or more operation have been completed based on the request/command by the user, the CAN transceiver 213 may receive the one or more result signals transmitted from the one or more vehicle components as illustrated in block 332. The CAN transceiver 213 may transmit the one or more return signals to the microprocessor 217 for extracting one or more return data packets for transmission to the ND 103 and/or 105 as in block 334. Transmission may be accomplished by the GSM antenna 201 over network 115.

Upon transmitting the one or more result data packets, as illustrated in block 336, the data packets may be transmitted to the remote terminals 103 and/or 105. In one embodiment, the return data packets may be routed through server(s) 101, as illustrated in block 338, which may or may not further process the data packets for transmission to the remote terminals 103 and/or 105. The result data packet(s) may be transmitted to (as illustrated in block 340) and received by the ND 103 and/or computer 105.

A report may be generated and displayed to the user as illustrated in block 342. The report may be generated each time the user requests one or more operations. Alternatively or additionally, the report may be generated at predetermined time intervals or according to a user preference (e.g., on a monthly basis or each time the user specifically requests a report).

In at least one illustrative embodiment, communication between a vehicle based cellular chip and a remote wireless device is possible. This communication can be used, among other things, to send GPS coordinates of a vehicle to the wireless device. The GPS coordinates can be transmitted to a wireless transceiver over a vehicle system bus or through another connection (for example, RF or BLUETOOTH, if the GPS is not connected to a vehicle system bus).

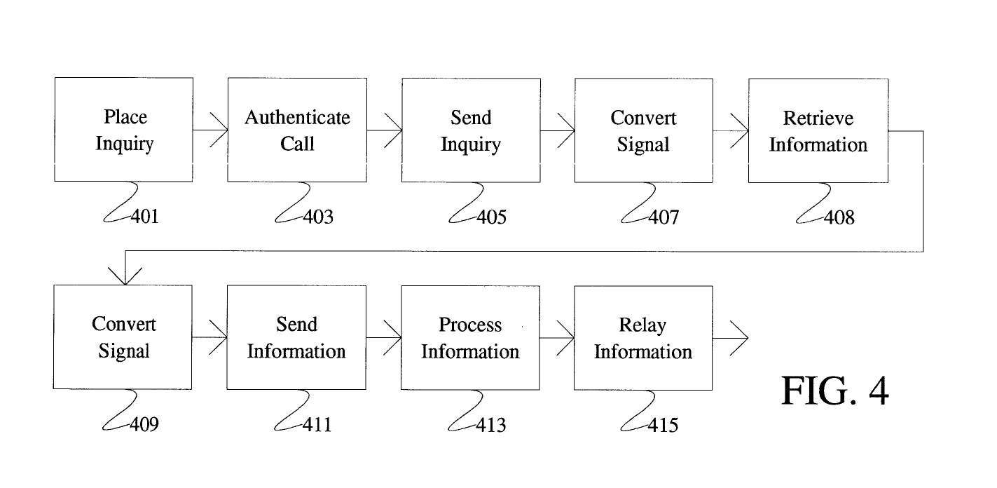

In a first illustrative embodiment, shown by example in FIG. 4, a user can check a variety of information “on-demand” from a vehicle system. An inquiry is placed to a network server 401. At the server, an authentication/validation process may occur 403 (this may additionally or alternatively occur at the vehicle itself), and the inquiry is sent to a vehicle 405 that has, for example, been previously correlated with a remote wireless device.

Upon receiving the inquiry, the vehicle may convert the incoming transmission into a signal usable by a microprocessor in the vehicle 407, and then perform an action corresponding to the inquiry.

Once the desired information has been retrieved 408, the signal is re-converted into a transmittable signal (if required) 409 and sent back to the server 411. The resulting information is then processed (if needed) 413 and relayed to the requesting remote device 415, where it can be displayed.

As some non-limiting examples, the following may be checked with such an on-demand inquiry. A user could query an engine state and determine whether or not a vehicle was left running (or had been turned on). As another example, a user could check to see if any doors or windows were fully or partially open. In addition to a yes/no answer to this query, a specific door or window could be identified. The same logic could be applied to a sunroof, lift gate, trunk and rear glass panel.

The status of a vehicle alarm could also be checked (and the alarm could be set/disabled). This could be a check to see if the alarm was armed or currently activating. Similarly, the wireless device could be used to arm or deactivate the alarm in the event the current state of the alarm was not in accord with a user's desired state for the alarm.

Other possible non-limiting inquiries that could be made include: checking a parking brake status, checking to see if the vehicle is in park, checking a fuel level, checking a cabin temperature, checking an underhood temperature, checking fluid temperatures.

In addition to checking information in a vehicle, the wireless device can be used to send information to be stored (and possibly later relayed) in a vehicle memory. For example, without limitation, grocery lists, schedules and work instructions (for, for example, employees driving a vehicle) could be sent to the vehicle.

Some more detailed examples of possible exemplary embodiments follow below.

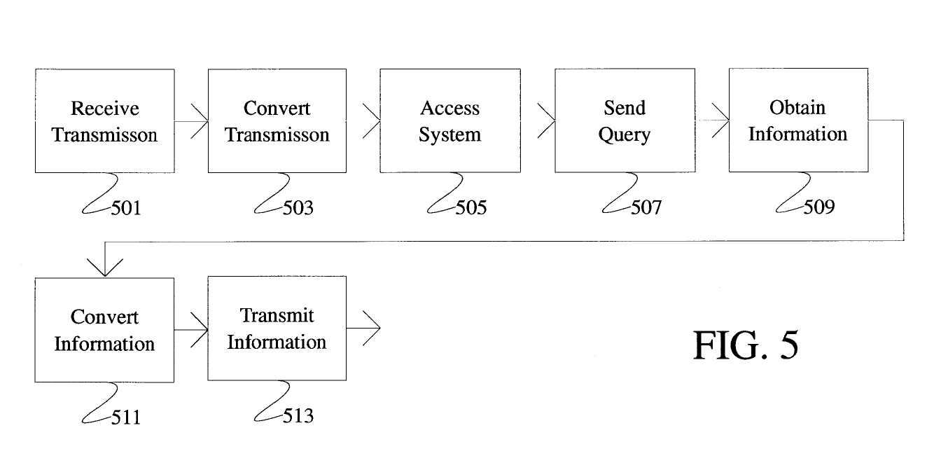

In one exemplary process shown in FIG. 5, a vehicle system receives an inquiry command from a remote network 501 transmitted to a cellular transceiver. The cellular transceiver includes a GSM chip, which converts the command into a format readable by a microprocessor of the vehicle 503. The microprocessor then reads the query and accesses the appropriate vehicle system (via, for example, RF) or system bus 505. The microprocessor, once it has identified the signal to be checked from the appropriate system or bus, sends an inquiry to the appropriate system 507 or checks a signal from the system being transmitted over the bus.

Once the microprocessor has obtained information that will satisfy the query 509, it sends the information back to the GSM chip for conversion to a transmittable signal format 511. The signal is then sent back through the cellular transceiver to a remote server 513.

The remote server may then take the signal and determine the device which posited the query initially 515. The device is then contacted, and the information sent by the vehicle system through the cellular network is transmitted to the appropriate device 517.

Other non-limiting examples of systems that can be checked by this inquiry include, but are not limited to, a seat belt engagement (for example, a parent could check if a child driving the car is wearing a seat belt), a car light on/off status (if the owner wished to know if they had left the car lights on), a hazard light status (including, for example, a possibility of a turn on command if the hazard lights are off, or a turn off command if the hazard lights are on), whether a parking brake is engaged and/or whether a vehicle is in park, a trailer connection status, and a VIN or odometer reading. This last piece of information could save time at a dealer or, for example, if requesting an insurance quote, it could prevent the owner from needing to walk out to the vehicle to obtain the information.

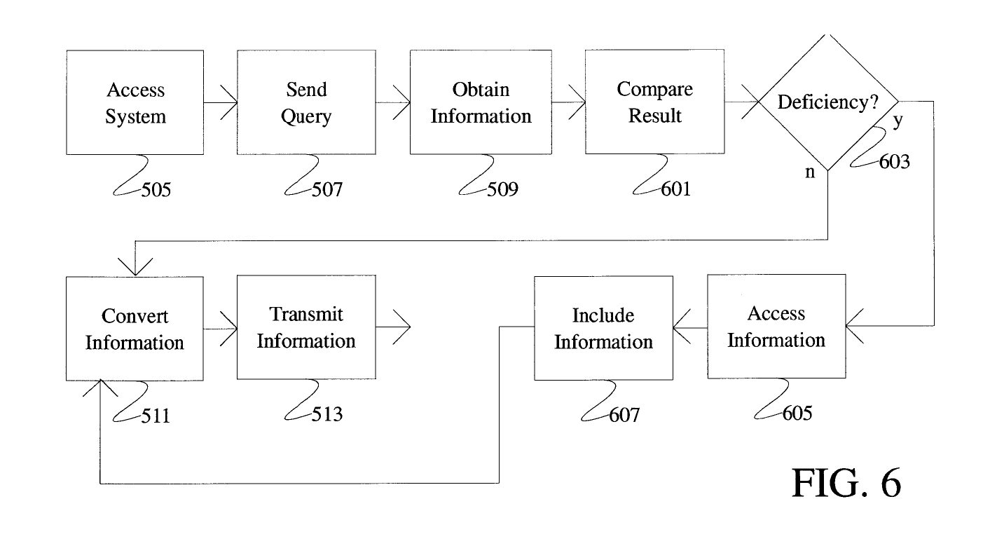

In another illustrative example, certain vehicle queries could result in additional information being transmitted back to the querant's remote device, as shown by example in FIG. 6. As before, a query could arrive at the microprocessor 505. Once the microprocessor has the desired result 509, the microprocessor can compare the result against a baseline state 601. For example, if the status of a replaceable vehicle system were checked (oil level, headlights, etc.), the light bulbs might be compared against an “operational” state and the oil might be compared against a “sufficient level state.”

If a deficiency is detected 603, the microprocessor may access information stored in a vehicle memory 605 (or broadcast by a vehicle system) that includes a replacement type (bulb type, oil weight, etc.). This additional information could then be packed with the state information 607 and sent to the cellular chip 511 for conversion for transmission. This information could also be stored off-board, on, for example, a server.

Accessed information could also include, but is not limited to, paint color, spark plug type, washer fluid level/type, etc. Essentially, any replaceable/repairable portion of the vehicle could be accessed.

When the user receives the information indicating a deficiency, the user will then also receive information advising the best replacement for the deficient part/fluid/system, etc. Other information, such as a date/mileage of a last oil change, could also be included. Additionally or alternatively, the user could simply query the vehicle for a part type, without actually checking the status of the corresponding system. This process could also be used to check a battery charge of an electric vehicle, so the user knows if the vehicle is ready for operation or needs more time, for example.

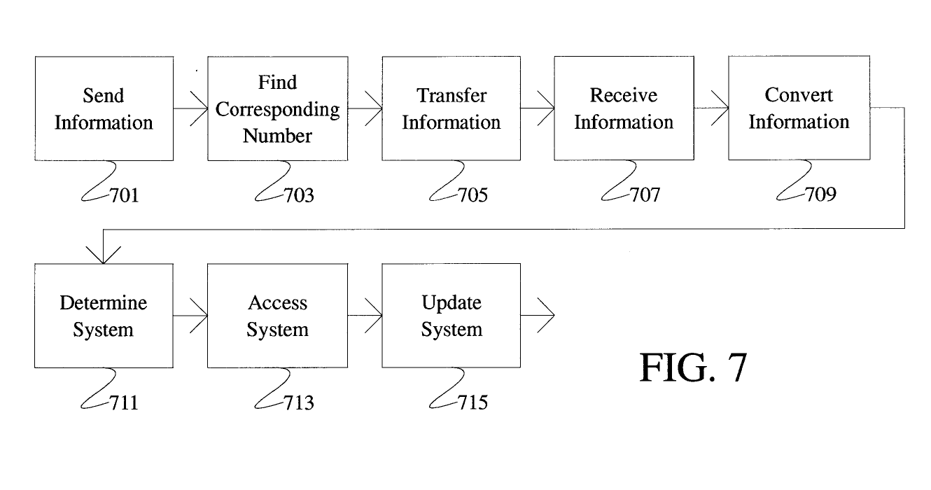

In another illustrative embodiment, shown in exemplary non-limiting fashion in FIG. 7, a vehicle system is updateable using a remote wireless device (or wired device, such as a PC).

In this illustrative embodiment, a user sends one or more pieces of information from the remote device to a server for processing 701. The server then authenticates the information transfer (if needed) and finds the cellular number corresponding to the request 703. Typically, this number is previously associated with a particular remote device. The server then transfers the information, via a cellular signal, to a cellular transceiver located in the vehicle 705.

Once the transceiver receives the information 707, it converts the information to a format usable by a vehicle microprocessor 709, using a GSM chip (the conversion may also be done by the microprocessor).

The microprocessor then determines what vehicle system is to be updated, based on the transferred information 711. A call to the system or to a vehicle system bus is then made to access the system to be updated 713, and the information is transferred to the system 715.

In one illustrative embodiment, this is a transfer of an owner's manual to a vehicle center stack, so that relevant manual information can be stored thereon. In another embodiment, a playlist, or an address book is updated from the remote device.

In yet another illustrative embodiment, a list of GPS locations that a remote device has traveled to is sent to a vehicle memory for storage. This could be useful, for example, in tracking a jogging route. The user could set a wireless remote device to transfer locations to the vehicle, and, upon returning to the vehicle, could have a stored set of points along which the user traveled.

In a further illustrative embodiment, the user may look up a location, business, etc., on a wireless remote device and there may be an address associated therewith. The user may then elect to transfer the address and/or phone information to the center stack. For example, if a user was doing last minute Christmas shopping, every second may count. The user could look up the address of the next destination on the wireless device as the user was walking to the vehicle, and transmit the information. By the time the user arrived at the vehicle, the information could be stored and or already queued up on a vehicle GPS.

What is claimed:

1. A method for vehicle querying comprising:
receiving an inquiry, initiated at a remote wireless device, at a vehicle-based transceiver;
querying one or more systems in accordance with the inquiry;
receiving information in accordance with the inquiry from the one or more systems;
transmitting the received information to the remote wireless device, wherein the one or more systems include at least one of a hazard light status, an oil level, a VIN and an odometer reading.

2. The method of claim 1, wherein the inquiry is sent from a remote server in communication with the remote wireless device and is initiated by the remote wireless device.

3. The method of claim 1, where the transmitting further includes transmitting the received information to a remote server through the transceiver, for further transmission to the remote wireless device.

4. The method of claim 1, further comprising converting the inquiry into a new format, wherein the new format is readable by a microprocessor included in the vehicle.

5. The method of claim 1, further comprising converting the received information into a new format, wherein the new format is readable by a cellular device.

6. The method of claim 1, wherein the querying one or more systems includes accessing a vehicle system bus.

7. The method of claim 1, wherein the querying one or more systems includes accessing an RF transceiver in communication with a vehicle system.

8. The method of claim 1, wherein the one or more systems include a connected status of one or more safety harnesses.

9. The method of claim 1, wherein a hazard light inquiry further includes a command instructing a desired state of the hazard lights, and wherein the method further includes:
processing the desired command such that a state of the hazard lights is changed to the desired state.

10. The method of claim 1, further comprising:
accessing stored data relating to a recommended oil type; and
including the stored data relating to the recommended oil type for transmission to the remote server.

11. The method of claim 1, further comprising:
accessing stored data relating to a oil life remaining; and
including the stored data relating to the oil life remaining for transmission to the remote server.

12. The method of claim 1, wherein the systems capable of being queried further include a bulb status inquiry.

13. The method of claim 12, further comprising:
accessing stored data relating to a recommended bulb replacement; and
including the stored data relating to the recommended bulb replacement for transmission to the remote server.

14. The method of claim 1, further comprising:
accessing stored data relating to a replaceable and/or repairable vehicle component; and
including the stored data relating to the replaceable and/or repairable vehicle component for transmission to the remote server.

15. The method of claim 14, wherein the data relating to a replaceable and/or repairable vehicle component includes at least one of a paint color, a spark-plug identification, a washer-fluid level and/or a washer-fluid type.

16. A method comprising:
receiving an update command, sent from a remote server in communication with a remote wireless device and initiated at the wireless device, at a vehicle-based cellular transceiver;
accessing one or more vehicle systems in accordance with the update command; and
updating the one or more accessed systems in accordance with the update command.

17. The method of claim 16, further comprising converting the update command into a new format, wherein the new format is readable by a microprocessor included in the vehicle.

18. The method of claim 16, wherein the update command includes one or more GPS coordinates.

19. The method of claim 18, wherein, upon receiving a GPS coordinate set with instructions to navigate to a location designated by the coordinate set, the method further includes:
updating a GPS system with the coordinate set as a destination coordinate set.

20. A computer readable storage medium storing one or more instructions executable by a processor in machine-readable format, wherein, upon execution of the instructions by a processor, the processor is caused to perform the steps comprising:
receiving an inquiry at a cellular transceiver included in a vehicle, the inquiry having been sent from a remote server in communication with the remote wireless device, the inquiry having been initiated by the remote wireless device;
accessing one or more vehicle systems in accordance with the inquiry;
querying the accessed one or more systems in accordance with the inquiry;
receiving information in accordance with the query from the one or more systems that were queried; and
transmitting the received information to the remote server through the cellular transceiver, for further transmission to the remote wireless device, wherein the systems capable of being queried include at least one of a hazard light status inquiry, an oil level inquiry, a VIN inquiry, a bulb status inquiry, and oil life inquiry and/or an odometer reading inquiry.
